(19) United States
(12) Patent Application Publication
(10) Pub. No.: US 2026/0361589 A1
(43) Pub. Date: Nov. 12, 2026

(54) LOW PEAK TO AVERAGE POWER RATIO PREAMBLE DESIGN

(71) Applicants: Qinghua Li, San Ramon, CA (US); Laurent Cariou, Milizac (FR); Danny Alexander, Neve Efraim Monoson (IL); Oren Ezra Avraham, Givat Shmuel (IL); Hila Ben Artzi, Herzliya (IL); Cheng Chen, Bentonville, AR (US); Carlos Cordeiro, Camas, WA (US); Yoav Eisenberg, Yehud-Monosson (IL); Juan Fang, Portland, OR (US); Chen Kojokaro, Yokne'am Illit (IL); Ratnesh Kumbhkar, Sunnyvale, CA (US); Uri Perlmutter, Holon (IL); Ehud Reshef, Kiryat Tivon (IL)

(72) Inventors: Qinghua Li, San Ramon, CA (US); Laurent Cariou, Milizac (FR); Danny Alexander, Neve Efraim Monoson (IL); Oren Ezra Avraham, Givat Shmuel (IL); Hila Ben Artzi, Herzliya (IL); Cheng Chen, Bentonville, AR (US); Carlos Cordeiro, Camas, WA (US); Yoav Eisenberg, Yehud-Monosson (IL); Juan Fang, Portland, OR (US); Chen Kojokaro, Yokne'am Illit (IL); Ratnesh Kumbhkar, Sunnyvale, CA (US); Uri Perlmutter, Holon (IL); Ehud Reshef, Kiryat Tivon (IL)

(21) Appl. No.: 19/715,901

(22) Filed: Jun. 22, 2026

Related U.S. Application Data
(60) Provisional application No. 63/849,298, filed on Jul. 23, 2025.
(60) Provisional application No. 63/867,568, filed on Aug. 20, 2025.
(60) Provisional application No. 63/870,731, filed on Aug. 26, 2025.

(51) Int. Cl. H04L 27/34; H04L 5/00

(52) U.S. Cl. CPC H04L 27/3411; H04L 5/0048; H04L 27/3444

(57) ABSTRACT

This disclosure describes systems, methods, and devices related to enhanced connectivity. A device may generate a preamble comprising a signal duplicated across a plurality of frequency portions of a bandwidth. The device may determine a phase rotation for each copy of the signal based on a number of the frequency portions. The device may apply the phase rotation to each copy to reduce a peak-to-average power ratio of the preamble. The device may transmit the preamble based on the phase rotation.

### CROSS-REFERENCE TO RELATED APPLICATION(S)

This application claims the benefit of U.S. Provisional Application No. 63/849,298, filed Jul. 23, 2025, U.S. Provisional Application No. 63/867,568, filed Aug. 20, 2025, and to U.S. Provisional Application No. 63/870,731 filed Aug. 26, 2025, the disclosures of which is incorporated herein by reference as if set forth in full.

### BACKGROUND

Wireless devices are becoming more prevalent, necessitating efficient access to wireless channels. Standards are evolving to enhance connectivity, integrating advanced technologies in modern networks.

### BRIEF DESCRIPTION OF THE DRAWINGS

FIG. 1 is a network diagram illustrating an example network environment for enhanced connectivity, in accordance with one or more example embodiments of the present disclosure.

FIGS. 2-7 depict illustrative schematic diagrams for enhanced connectivity, in accordance with one or more example embodiments of the present disclosure.

FIGS. 8-11 depict illustrative schematic diagrams for enhanced transmission timing, in accordance with one or more example embodiments of the present disclosure.

FIGS. 12-13 depict illustrative schematic diagrams for enhanced bandwidth integration, in accordance with one or more example embodiments of the present disclosure.

FIG. 14 illustrates a flow of a process for an illustrative enhanced connectivity system, in accordance with one or more example embodiments of the present disclosure.

FIG. 15 illustrates a functional diagram of an exemplary communication station that may be suitable for use as a user device, in accordance with one or more example embodiments of the present disclosure.

FIG. 16 illustrates a block diagram of an example machine upon which any of one or more techniques (e.g., methods) may be performed, in accordance with one or more example embodiments of the present disclosure.

FIG. 17 is a block diagram of a radio architecture in accordance with some examples.

FIG. 18 illustrates an example front-end module circuitry for use in the radio architecture of FIG. 17, in accordance with one or more example embodiments of the present disclosure.

FIG. 19 illustrates an example radio IC circuitry for use in the radio architecture of FIG. 17, in accordance with one or more example embodiments of the present disclosure.

FIG. 20 illustrates an example baseband processing circuitry for use in the radio architecture of FIG. 17, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Wi-Fi 8 (IEEE 802.11bn or ultra high reliability (UHR)) is the next generation of Wi-Fi and a successor to the IEEE 802.11be (Wi-Fi 7) standard. In line with all previous Wi-Fi standards, Wi-Fi 8 will aim to improve wireless performance in general along with introducing new and innovative features to further advance Wi-Fi technology.

The preamble of 802.11bq is likely to have a duplicate structure in frequency like Wi-Fi 4-8 preambles. It is known that the duplicate structure increases the peak to average power ratio (PAPR) of the transmit signal. Methods are suggested to reduce PAPR.

A global binary phase is applied to each 20 MHz subchannel in the duplicate non-HT transmission for Wi-Fi 4-8.

The PAPR can be further reduced together with other methods.

A design was proposed where a training field (TRN) for beam refinement (BRP) is inserted between IMMW-STF and IMMW-LTF for getting the 8 microseconds (us) Tx ramp-up time.

BRP TRN should be optional because BRP training is not needed for every single PPDU. It is desirable that BRP TRN sits at the end of the PPDU so that BRP TRN can be used as packet extension (PE) as well and the beam measurement/adjustment is fresh for the next PPDU.

Modern wireless communication demands high data throughput, low latency, and efficient spectrum utilization, which has driven interest in the use of millimeter wave (mmWave) frequencies, particularly around 60 GHz. However, integrating mmWave operation into existing multi-band devices, which already operate in lower WiFi bands (such as 2.4, 5, and 6 GHz) presents several technical challenges.

A primary problem lies in designing efficient and flexible channelization and bandwidth allocation strategies for the 60 GHz band. The goal is to maximize reusability of existing PHY OFDM designs while adapting them for much wider channel bandwidths (320, 640, or 1280 MHz) that mmWave enables. Upclocking existing OFDM numerology by a factor of eight is a potential solution, but it requires careful adaptation to ensure compatibility, efficient operation, and cost-effectiveness.

Another significant challenge involves managing dynamic versus static bandwidth operation. In existing lower bands, devices can dynamically adjust transmit bandwidth based on channel availability (dynamic BW operation) or use a fixed bandwidth (static BW operation). However, the characteristics of the mmWave spectrum, including its relatively interference-free environment, suggest that static bandwidth operation could be feasible and even desirable for both transmission and reception. Yet, this simplification must be balanced against support for all possible use cases and the ability to reduce costs per device.

Therefore, the problem addressed here is how to define and implement integrated mmWave operation at 60 GHz for multi-band devices, while ensuring compatibility with existing WiFi standards, simplifying device operation, and allowing for efficient use of wide bandwidth channels. The solution must also enable support for various use cases, maintain device cost efficiency, and adapt to the unique characteristics of the millimeter wave medium.

Example embodiments of the present disclosure relate to systems, methods, and devices for 11bq Low PAPR preamble.

There may be five methods available to reduce the PAPR of the preamble, which may be applied separately or in combination.
1) Apply a global phase rotation to each copy of the duplicated signal.
2) Apply different cyclic shift diversity (CSD) shifts to different copies of the duplicated signal, respectively.
3) Apply different phase masks to different copies of the duplicated signal, respectively.
4) Reduce the number of active subcarrier for some of the preamble portion.
5) Map subcarrier symbols differently on different copies.

One or more advantages include: The PAPR reduction makes the preamble detection reliable. Enable mmWave in low-cost Wi-Fi for bringing higher throughput and lower latency customers.

Example embodiments of the present disclosure relate to systems, methods, and devices for on transmit chain ramp-up.

Several alternative solutions are proposed, most of which keep the beam refinement protocol (BRP) training (TRN) at the end of the physical layer (PHY) convergence protocol data unit (PPDU).

One or more advantages include: enabling mmWave in low-cost Wi-Fi for bringing higher throughput and lower latency.

Example embodiments of the present disclosure relate to systems, methods, and devices for integrated millimeter wave (IMMW) operation at 60 GHz with a static receive bandwidth.

The following bandwidths are proposed for definition in 11bq: 320 MHz, 640 MHz, and possibly 1280 MHz; inclusion of 160 MHz as an option is also possible.

Devices may be configured to indicate support for their maximum BW, similar to the approach used on the lower band. A BW static mode can also be established, where the BW used in the mmWave band for PPDUs exchanged between two peers remains constant. Several solutions to determine this BW are suggested.

In one or more embodiments, a device may be configured to advertise its maximum supported bandwidth (BW) during the initial setup or association phase. For example, a device could signal that it supports up to 640 MHz BW through a capability exchange with its peer device. This allows both devices to negotiate and agree on the optimal BW for communication on the mmWave band.

In one or more embodiments, a static bandwidth mode may be established so that all data packets exchanged between two devices use a predetermined, fixed BW. For example, after negotiation, both devices may set their communication channel to 320 MHz for all future transmissions, ensuring consistent behavior and reducing the complexity of switching BWs dynamically.

In one or more embodiments, various methods can be used to determine and set this static BW. For example, this could involve exchanging management frames that specify the agreed BW, or using specific control signals in the protocol to confirm the chosen BW for both uplink and downlink communications. This approach helps standardize the operation and makes sure that both the transmitter and receiver are aligned regarding the BW for all packet transmissions.

In one or more embodiments, a device or a system may comprise one or more components, which may include one or more of: apparatus, station (STA), access point (AP), and/or other network elements. At its most basic configuration, the device or system includes one or more processors, memory, and instructions. The processor(s) may be implemented using general-purpose microprocessors, digital signal processors (DSPs), field-programmable gate arrays (FPGAs), or other suitable computational entities capable of performing calculations or manipulations of information. The memory may include RAM, ROM, flash memory, or other storage media suitable for storing instructions and data necessary for system operation. These components, individually or in combination, enable the execution of processes that facilitate communication and functionality within the system.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

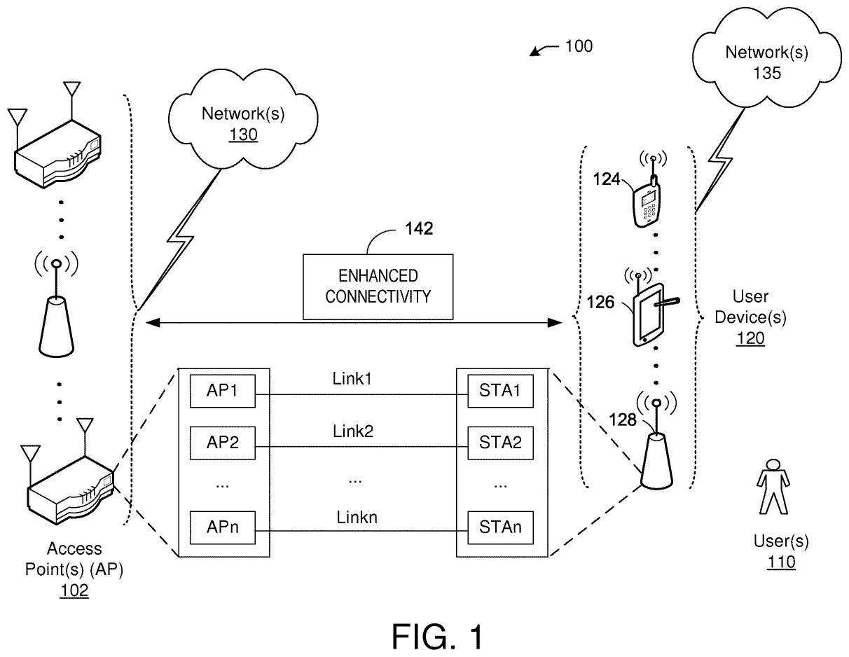

FIG. 1 is a network diagram illustrating an example network environment of enhanced connectivity, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

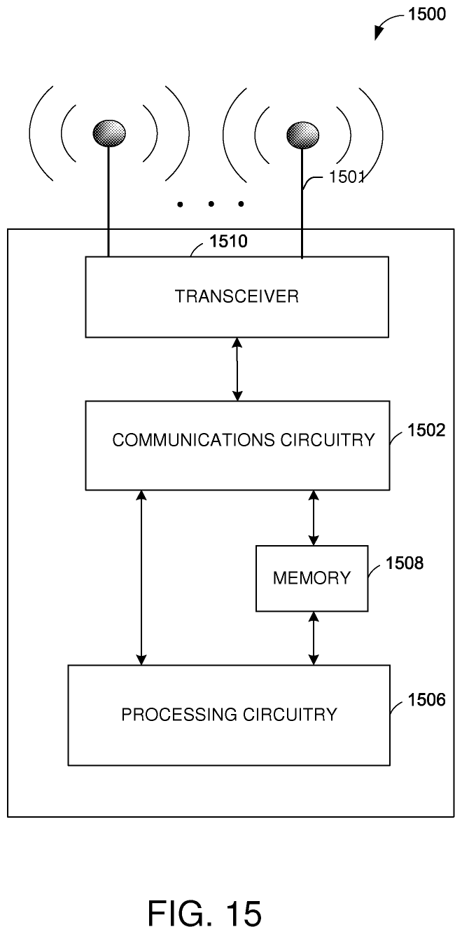

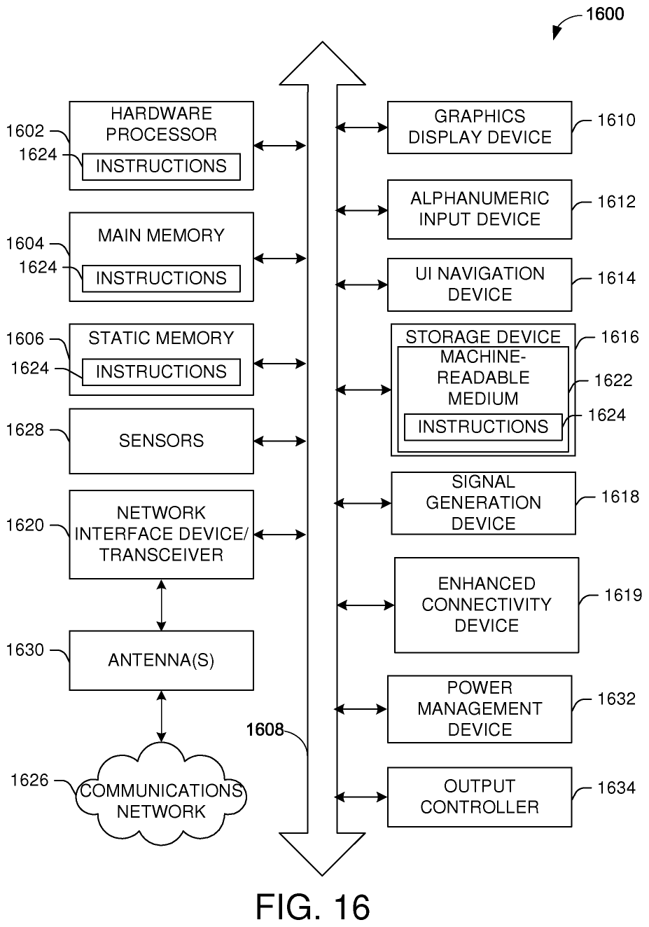

In some embodiments, the user devices 120 and the AP 102 may include one or more computer systems similar to that of the functional diagram of FIG. 15 and/or the example machine/system of FIG. 16.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax, 802.11be, 802.11bn, etc.), 6 GHz channels (e.g., 802.11ax, 802.11be, 802.11bn, etc.), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1, a user device 120 may be in communication with one or more APs 102. For example, one or more APs 102 may implement an enhanced connectivity 142 with one or more user devices 120. The one or more APs 102 may be multi-link devices (MLDs) and the one or more user device 120 may be non-AP MLDs. Each of the one or more APs 102 may comprise a plurality of individual APs (e.g., AP1, AP2, . . . , APn, where n is an integer) and each of the one or more user devices 120 may comprise a plurality of individual STAs (e.g., STA1, STA2, . . . , STAn). The AP MLDs and the non-AP MLDs may set up one or more links (e.g., Link1, Link2, . . . , Linkn) between each of the individual APs and STAs. It is understood that the above descriptions are for the purposes of illustration and are not meant to be limiting.

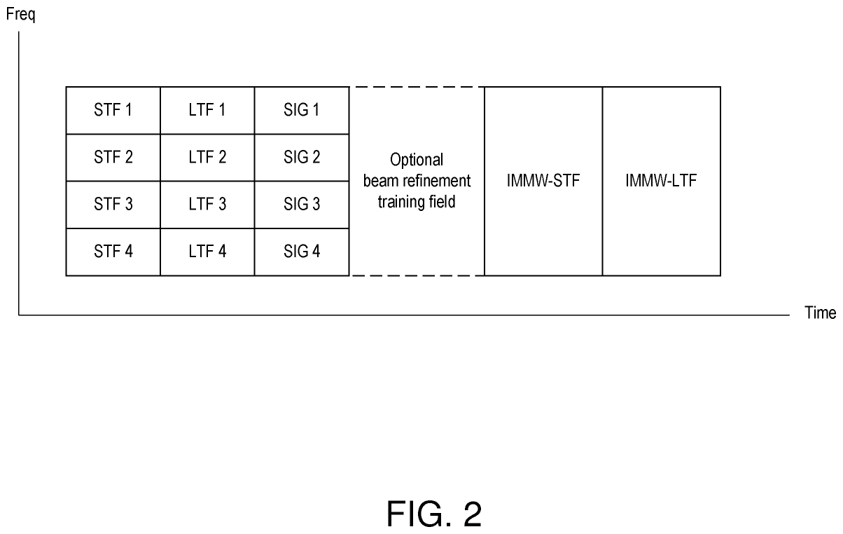

FIGS. 2-7 depict illustrative schematic diagrams for enhanced connectivity, in accordance with one or more example embodiments of the present disclosure.

A preamble structure under discussion is shown in FIG. 2. For the first three fields, i.e., STF, LTF, and SIG, they are duplicated in frequency. The duplication number depends on the bandwidth. The duplicated transmission causes high PAPR in time domain. Four methods can be applied individually or jointly or partially jointly to reduce the PAPR. In terms of 802.11 specification (“spec”) change, the transmitter or the spec needs to indicate whether the transmitted signals are different across different portions of the band. If there is a difference and the difference is unknown to the receiver, the receiver cannot do channel smoothing across different portions of the band. The transmitter or the spec may indicate whether the receiver can do the channel smoothing across different portions of the band. Or, the transmitter or the spec may simply specify that channel smoothing is not supported across the different portions because the transmitted signals are different on the portions.

### Method 1—Global Phase Rotation:

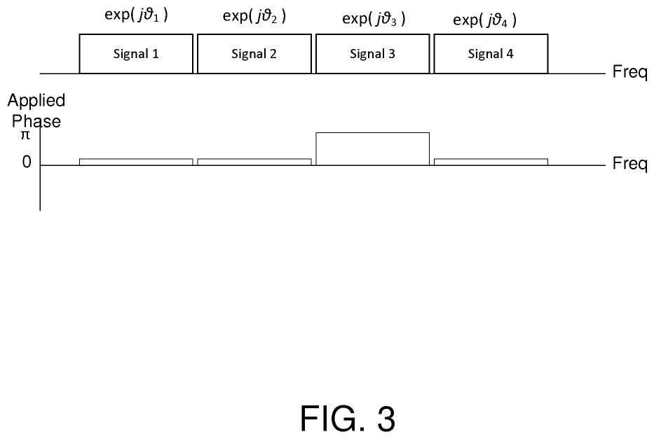

This method is used by the duplicate non-HT transmission of 802.11n/ac/ax/be/bn. A global phase rotation is applied to each copy of the signal as illustrated in FIG. 3. For example, binary phases 1, 1, −1, 1 are applied to the four copies, respectively in FIG. 3. For simplicity, binary phases or quaternary phases like (1, j, −1, −j) can be used. The phase rotation for the subcarriers of the signal copy remains the same.

### Method 2—CSD Shift:

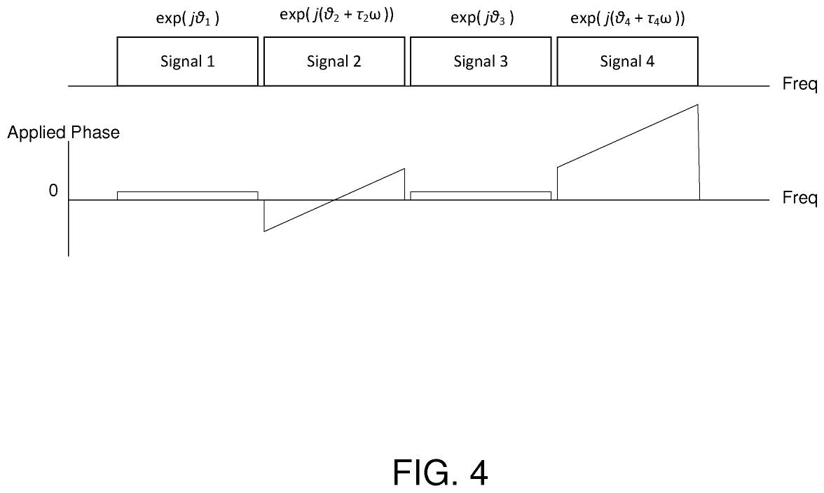

It was proposed to apply different CSD shifts to different subchannels, respectively for reducing the preamble PAPR as illustrated in FIG. 4. In FIG. 4, Method 1 and different CSD shifts are jointly used such that a linear phase shift is applied to each copy of the transmitted signal. The linear phase shift can be expressed as θₙ+τₙω, where θₙ is the global phase for signal copy n, τₙ is the CSD value for signal copy n, and ω is the frequency taking the phase shift.

### Method 3—Phase Mask:

It was proposed to apply different phase masks to different signal copies, respectively. For simplicity, the phase mask is a periodic and binary sequence. The period may be 4 subcarriers. This idea can be applied to 802.11bq preamble. The phase mask sequence can be generalized to non-binary sequences (e.g., quaternary sequences). The period can be numbers other than 4. No periodic sequences can be used as well. Each element of the mask sequence is multiplied with the corresponding symbol on a subcarrier to rotate the phase of the symbol. Unlike Method 1, the phase rotation varies with the elements of the mask sequence across the subcarriers of each signal copy. For reducing the implementation complexity, the phase rotation or masking may not be applied to the pilot subcarriers in Methods 1-3.

### Method 4—Active Subcarrier Reduction:

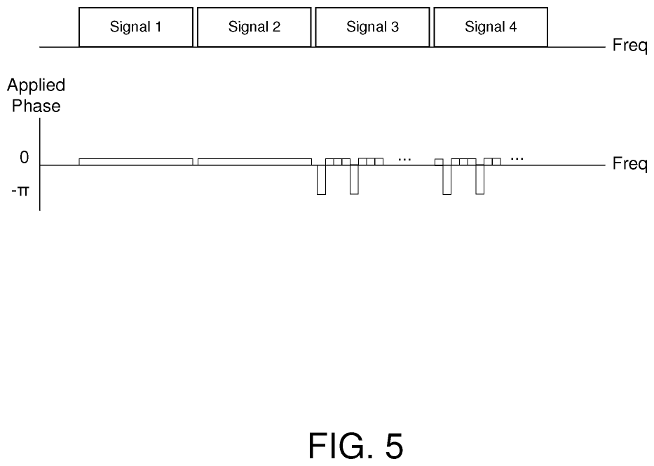

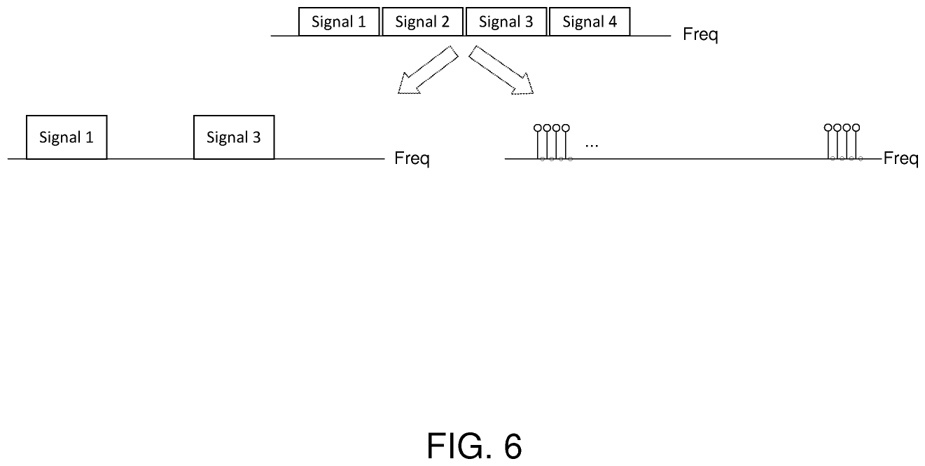

Because the PAPR increases as the number of active subcarriers, it is proposed to reduce the number of active subcarriers for reducing the PAPR. In FIG. 5, four copies of the signal are sent in the preamble portion. The number of copies can be reduced to three, two, and even one. Because the channel bandwidth of the PPDU remains unchanged, some of the subcarriers are inactive. The active subcarriers can concentrate on some subchannel(s) or spread over the channel bandwidth as illustrated in FIG. 6. The power of the active subcarrier can be boosted because no power is allocated to the inactive (or null) subcarriers.

### Method 5—Different Signal Mapping:

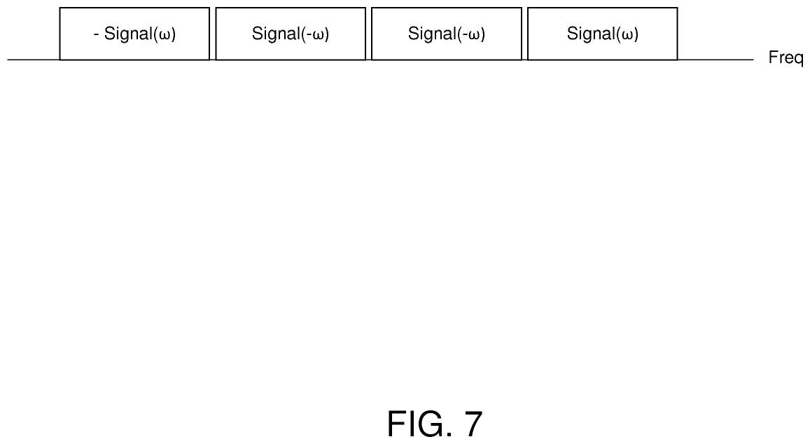

The signal for duplication can be mapped to different portions of the band differently for reducing the PAPR. For example, the orders of the symbol sequence and the constellation mappings of the symbol can be different for different copies. Let Signal(−ω) and Signal(ω) denote two signals whose symbol sequences in frequency domain have reverse orders each other. For example, Signal(ω) maps symbol 1 to subcarrier 1, symbol 2 to subcarrier 2, and symbol 3 to subcarrier 3, while Signal(−ω) maps symbol 1 to subcarrier 3, symbol 2 to subcarrier 2, and symbol 3 to subcarrier 1. Let Signal Signal*(ω) denote the conjugate of Signal(ω). It should be noticed that Signal(ω)=Signal*(ω) if Signal(ω) is real without imaginary components. Signal(ω), Signal*(ω), and −Signal(ω) can be to reduce the PAPR. A design example is shown in FIG. 7.

It is understood that the above descriptions are for the purposes of illustration and are not meant to be limiting.

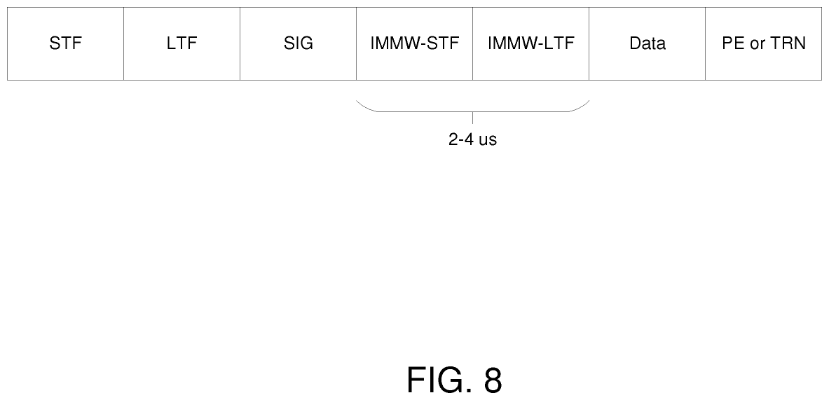

FIGS. 8-11 depict illustrative schematic diagrams for enhanced transmission timing, in accordance with one or more example embodiments of the present disclosure.

A general structure of integrated millimeter wave (IMMW) PPDU is illustrated in FIG. 8. Between the PHY layer preamble, SIG, and the Data field, IMMW-STF and IMMW-LTF take about 2-4 microseconds (us). The transmit chain (Tx), needs to ramp up for transmitting the response PPDU after receiving an intended PPDU. It is desired that the Tx ramp up, e.g., power on and calibration, happens between SIG and Data such that no major architecture change is needed. In current implementation, the Tx ramp-up takes about 8 microseconds (us) and can't run together with Data demodulation and decoding due to incompatible hardware usage.

The description below is for 8 us Tx ramp-up time. The 8 us may be changed to other numbers like 6 us or 4 us depending on the final implementation. The proposed options can be used jointly or individually.

### Option 1—Longer IMMW-STF and IMMW-LTF:

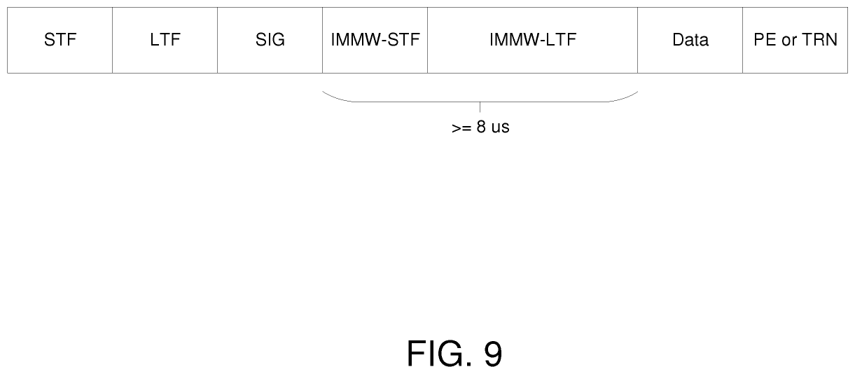

Instead of the insertion of BRP TRN, the optional BRP TRN stays at the end of the PPDU as illustrated in FIG. 9. The total duration of IMMW-STF and IMMW-LTF is made longer than 8 us. Depending on the subcarrier spacing, IMMW-STF is usually 1-2 us long and IMMW-LTF is usually 0.5-1 us long. Therefore, the total duration of IMMW-STF and IMMW-LTF is 1.5-4 us long. Propose using an IMMW-LTF longer than normal.

For example, the standard IMMW-LTF has one OFDM symbol for one spatial stream PPDU and takes about 0.5-1μs. Instead of a single OFDM symbol, two OFDM symbols are used for one stream PPDU. This makes the IMMW-LTF 2 us long. More than two IMMW-LTF symbols, e.g., 4 OFDM symbols, may be used to get additional Tx ramp-up time. It should be noticed that the multiple IMMW-LTF symbols improve the channel estimation quality. The estimation of phase noise correlation can be improved as well. For reliable AGC setting and additional Tx ramp-up time, IMMW-STF can be also extended from the normal 1-3 us to 4 us or longer. If it is not possible to make the total duration equal to or longer than 8 us, the goal is to maximize the total duration—for example, 6 us—by allocating 4 us for IMMW-STF and 2 us for IMMW-LTF.

### Option 2—Early Rx ID Notification:

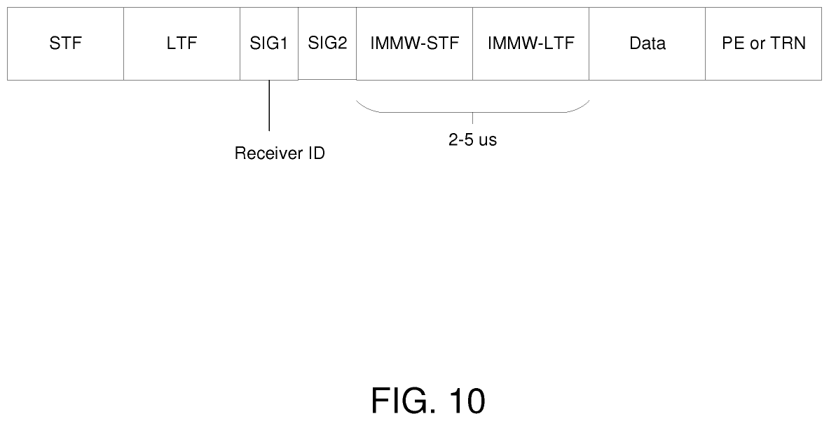

In this option, it is assumed that the receiver can start the Tx ramp-up after receiving receiver (Rx) ID and other necessary information. For example, if the receiver knows it is the intended receiver of the PPDU and the PPDU requires an immediate response, the receiver needs to ramp up its transmit chain. A solution is proposed as illustrated in FIG. 10. The receiver (Rx) ID and other information necessary for the receiver to start the Tx ramp up are sent as early as possible, e.g., right after LTF. The SIG field is split into multiple portions, each of which has its tail bits and/or CRC bits. Each portion can have one or multiple OFDM symbols. In the first portion, denoted by SIG 1, the receiver ID and other necessary information are sent. For example, 11-bit AID (or another short Rx ID), 1-bit immediate response requirement, 4-bit CRC, 6 tail bits, and a short transmitter ID (like BSS color) can be encoded by BCC with code rate ½, be modulated by BPSK, and be sent in the first OFDM symbol. If there is not enough room in the first OFDM symbol for all the information, the short Rx ID has the highest priority to be in the first portion. The first SIG portion, SIG 1, may be defined as universal SIGNAL field denoted by U-SIG.

Instead of a FEC codeword, another way to send the Rx ID is to use sequences like those used by the ELR-Mark in 802.11bn.

### Option 3—Notification PPDU:

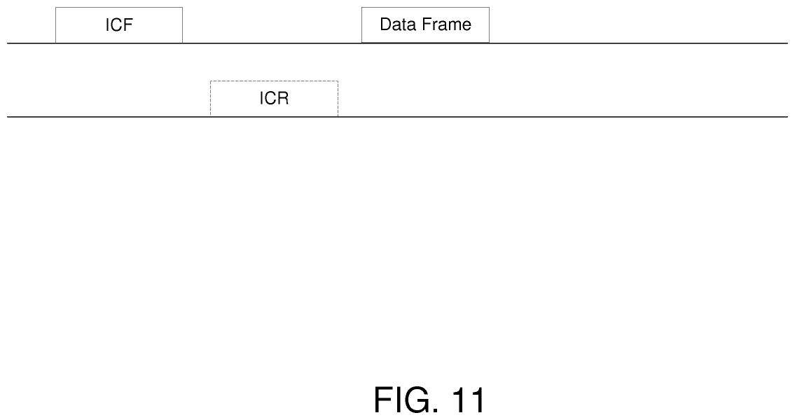

In 802.11bn, initial control frame (ICF) was developed to bring up the receiver capability for the actual data reception. Similar ideas can be used for the Tx ramp-up instead of the receiver capability. A PPDU may be sent before the actual data PPDU such that the receiver can ramp up the Tx chain ahead of time. An example is illustrated in FIG. 11. Because the receiver of the ICF may not be able to ramp up its Tx chain when receiving the ICF, the ICR frame may not be sent. Namely, the transmitter sends the receiver a short PPDU with the notification of the subsequent Data frame and the notification doesn't require a response frame. The notification may be carried by a new control frame or a modification of an existing frame like ICF, CTS, and RTS. After receiving the notification PPDU, the receiver knows it is the receiver of the subsequent PPDU and a response transmission is needed.

In one or more embodiments, the BRP TRN is between IMMW-STF and IMMW-LTF. As an alternative, the order of the IMMW-STF, BRP TRN, and IMMW-LTF can be changed. For example, the order can be BRP TRN, IMMW-STF, and IMMW-LTF. Or the order can be IMMW-STF, IMMW-LTF, and BRP TRN. Besides, the BRP TRN can be replaced by another signal, e.g., another PHY preamble symbol (or portion), e.g., SIG 2 or SIG 3.

It is understood that the above descriptions are for the purposes of illustration and are not meant to be limiting.

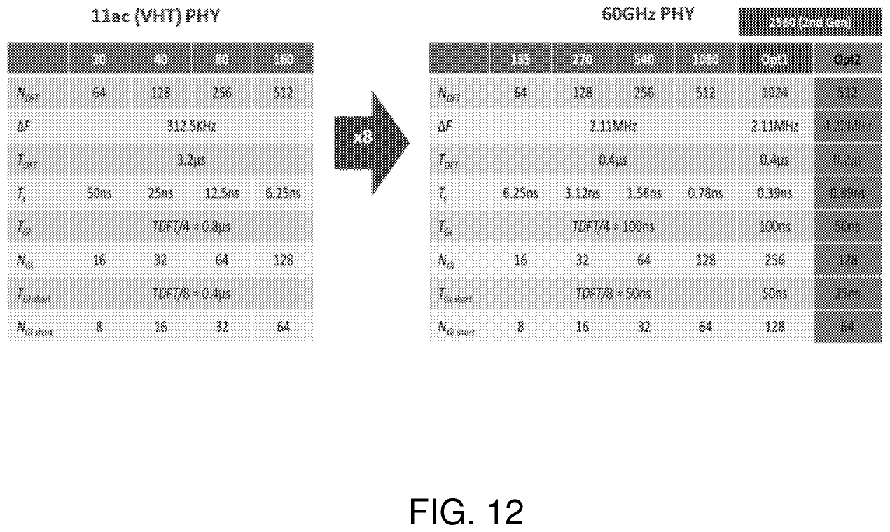

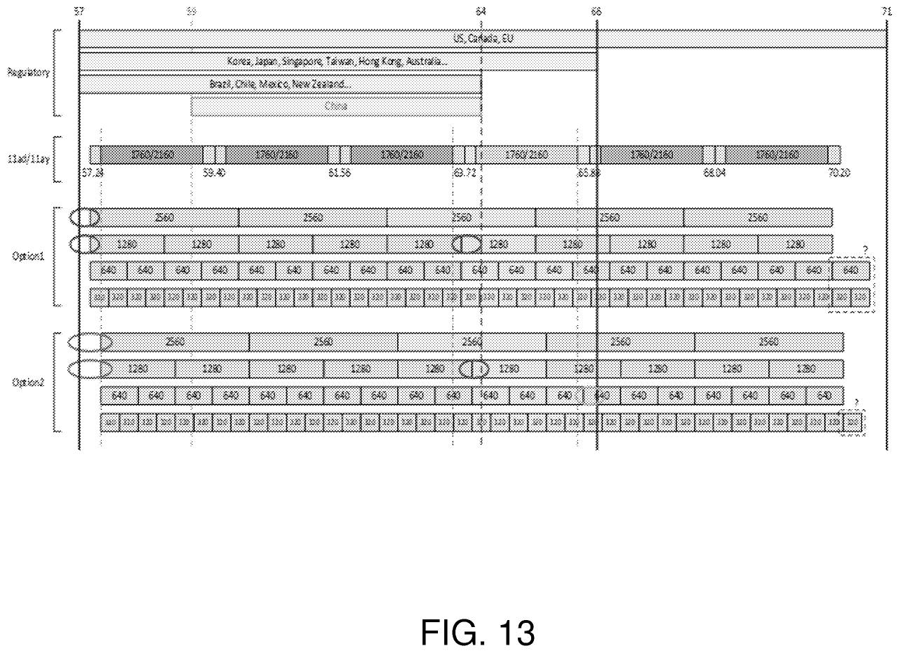

FIGS. 12-13 depict illustrative schematic diagrams for enhanced bandwidth integration, in accordance with one or more example embodiments of the present disclosure.

Approval has been granted for the creation of 11bq, which will design operation in mmWave unlicensed bands with the following constraints and requirements:
Only for devices that are multi-band and that can operate both in mmWave and in lower WiFi bands (2.4, 5 and/or 6 GHz).
Trying to reuse as much as possible the current PHY OFDM design from the lower bands. It is possible to use OFDM numerology from 11ac and previous generations and upclock it by 8 times.

Referring to FIG. 12, there is shown an illustration of OFDM parameters at 60 GHz when upclocking by 8x.

Referring to FIG. 13, there is shown a channelization with channels of 320/640/1280 MHz in the 60 GHz band.

With this concept, multiple bandwidth modes can be defined using channel bonding as in the lower band (where 20, 40, and 80 MHz become 160, 320, or 640 MHz), each bandwidth featuring different tone plans as established in the lower frequencies.

Typically, in the lower bands, when a STA supports a max BW, it supports all the BWs that are lower. A STA on the transmit side can have dynamic BW operation, where it can adjust the BW it will use within a gained TxOP, based on the availability of the different 20 MHz channels during CCA operation prior to gaining the TxOP. Some STAs can also have static BW operation on transmit side, in the sense that they can only access the medium on a particular BW (that is not announced ahead of time and could therefore change during the operation), and when they run CCA to access the medium, they can start a TxOP only if all 20 MHz channels constituting the particular static BW are idle. And if some of the 20 MHz channels are busy, then they abort the transmission and retry and access the medium later.

On the receive side however, STAs can receive PPDUs with any BW that is equal or lower than their capability, and adjust their reception based on the BW information contained in the SIG fields in the PHY PPDU header.

In mmWave, it is possible to simplify operation because there will be way less interference on the medium (easier to find channels that are free of interference), and CCA function doesn't necessarily need to differentiate between sub-channels (which would be 160 MHz channels constituting the wider bandwidth). That would then mean possibly static BW operation both on transmit and on receive side.

The following bandwidths are proposed for definition in 11bq:
320 MHz
640 MHz
Possibly 1280 MHz
(it is possible to also define 160 MHz).

A device may indicate support for its maximum bandwidth, similar to procedures on the lower band. A static bandwidth mode can then be established, ensuring that the bandwidth used in the mmWave band for PPDUs exchanged between two peers remains constant. Several solutions are proposed to determine this bandwidth:

An implicit determination if the static mode is enabled/used:
In that case, the BW is simply the largest BW that is supported by both the IMMW AP and the IMMW STA and that is lower or equal to the BSS BW or between the 2 peer STAs. (similarly to the max BW of a STA based on supported capabilities in the lower band, except that in the case here, that BW will be the only possible PPDU BW that can be used).

An explicit indication of static BW, which is done in a long-term manner:
Management frame exchange between the IMMW AP and IMMW STA (likely transmitted in the lower band by APs/STAs that are part of the same AP MLD/non-AP MLD thanks to the MLO framework) used to determine the static BW that will be used. Could be one BW for both DL and UL or 2 separate BWs values for the 2 cases. Such management frame exchange can be a new dedicated management frame exchange, or it can be done as part of the association management frame exchange.

An explicit indication of static BW, which is done in a short-term manner:
In the TWT element or other new management or control frames used and transmitted in the lower band or in the mmWave band to schedule (periodic) operation on the IMMW link.
In a sort of trigger frame if such a frame is defined in the lower band to schedule immediately or short after some transmissions in the IMMW link.

With such static BW operation, both the receiver and the transmitter operate only with this BW and will transmit/receive PPDUs only with this fixed BW.
On the receiver side, this can help the receiver improve some detection functions, for instance the L-STF detection, which is typically done per 20 MHz in the lower band, and therefore per 160 MHz in the iMMW band because the BW is unknown at this early stage of the PPDU reception. If the BW is fixed, the receiver can receive and combine signals from multiple 160 MHz channels (which are the same signal that is duplicated on the transmit side on each 160 MHz channel) constituting the total static BW, which has the benefit of receiving more useful energy and averaging the noise. The correlation with the known STF sequences can therefore be done on a signal that is the combination of all 160 MHz signals received on the static BW.
Some other functions can be improved, such as the detection of the SIG fields. For instance, if it is desired to keep the L-SIG field in the PPDU format, and not change too much the PPDU design and the receiver procedure for IMMW compared to the one used in lower band, it is possible to keep the L-SIG after the L-STF, L-LTF and before a possible U-SIG and IMMW SIG. The L-SIG being slightly less robust than new U-SIG and IMMW SIG fields, it can be the bottleneck on the receive side. Similarly, the L-SIG will be computed on a 160 MHz BW and duplicated over all 160 MHz channels of the static BW of the PPDU, and on the receiver side, it is then possible to combine all signals received on every 160 MHz channels contained in the total static BW, in order to average the noise and ensure that L-SIG reception is no longer a bottleneck. Note that this can be done also for U-SIG and IMMW SIG.

It is understood that the above descriptions are for the purposes of illustration and are not meant to be limiting.

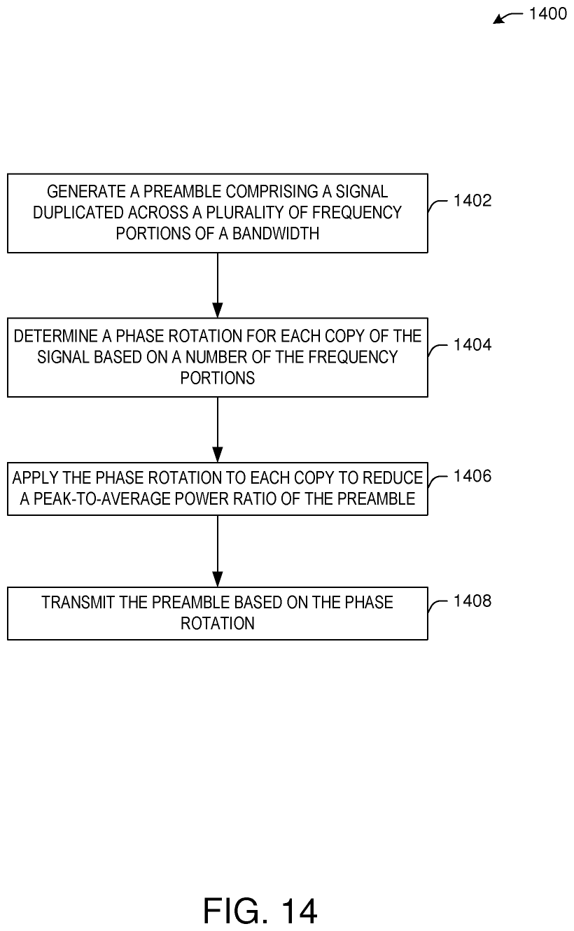

FIG. 14 illustrates a flow of illustrative process 1400 for an enhanced connectivity system, in accordance with one or more example embodiments of the present disclosure.

At block 1402, a device (e.g., the user device(s) 120 and/or the AP 102 of FIG. 1 and/or the enhanced connectivity device 1619 of FIG. 16) may generate a preamble comprising a signal duplicated across a plurality of frequency portions of a bandwidth.

At block 1404, the device may determine a phase rotation for each copy of the signal based on a number of the frequency portions.

At block 1406, the device may apply the phase rotation to each copy to reduce a peak-to-average power ratio of the preamble.

At block 1408, the device may transmit the preamble based on the phase rotation.

In one or more embodiments, a device or a system may apply a phase rotation comprising a global phase rotation to each copy, where the global phase rotation may be a binary phase or a quaternary phase. The purpose here is to lower the peak-to-average power ratio of a transmitted preamble: when identical copies of a signal are repeated across a bandwidth, their peaks tend to align and reinforce one another, which may stress the power amplifier and force a power back-off; applying a different global phase to each copy may de-correlate those peaks so they no longer add up coherently. In one or more embodiments, a device or a system may, for example, multiply a first copy by a phase of 0 degrees and a second copy by a phase of 180 degrees under a binary scheme, or rotate successive copies through 0, 90, 180, and 270 degrees under a quaternary scheme.

In one or more embodiments, a device or a system may apply a respective cyclic shift to each copy, where the phase rotation may comprise a linear phase shift based on a global phase and the respective cyclic shift. A cyclic shift in the time domain may correspond to a linear phase ramp across the subcarriers in the frequency domain, so combining a per-copy global phase with a per-copy cyclic shift may give the device two independent levers for spreading the signal energy and further smoothing the peak-to-average power ratio.

In one or more embodiments, a device or a system may apply a phase mask to each copy, where the phase mask may comprise a binary sequence. A binary phase mask may, for example, flip the sign of selected subcarriers according to a fixed pattern, which may be inexpensive to implement while still breaking up coherent peak alignment.

In one or more embodiments, a device or a system may apply a phase mask comprising a non-binary sequence or a non-periodic sequence, where each element of the phase mask may be multiplied with a symbol on a corresponding subcarrier. A non-binary or non-periodic mask may offer finer control than a simple binary pattern; for instance, a pseudo-random non-periodic sequence may scatter the phase relationships across subcarriers so that the repeated structure of the preamble does not produce a single dominant peak.

In one or more embodiments, a device or a system may reduce a number of active subcarriers of the preamble based on the peak-to-average power ratio. When the measured peak-to-average power ratio remains high, the device may deactivate a subset of subcarriers, since fewer simultaneously active tones may reduce the worst-case constructive addition of their waveforms.

In one or more embodiments, a device or a system may boost a power of an active subcarrier based on an inactive subcarrier of the bandwidth. Power budget that would have been spent on an inactive subcarrier may instead be reallocated to an active one, so that reducing the active subcarrier count need not reduce the overall transmitted energy or the detectability of the preamble.

In one or more embodiments, a device or a system may map a first copy and a second copy of the signal based on different symbol orders or different constellation mappings. Mapping the two copies differently, for example by reordering the symbols or by using a different constellation labeling for each copy, may further reduce correlation between the copies and therefore help suppress peaks.

In one or more embodiments, a device or a system may generate an indication of whether channel smoothing is supported across the frequency portions. Because deactivating subcarriers or applying per-portion phase treatment may leave gaps that disrupt a receiver's assumption of a smooth channel response, the device may signal whether channel smoothing remains valid across the frequency portions so that the receiver may adjust its channel estimation accordingly.

It is understood that the above descriptions are for the purposes of illustration and are not meant to be limiting.

FIG. 15 shows a functional diagram of an exemplary communication station 1500, in accordance with one or more example embodiments of the present disclosure. In one embodiment, FIG. 15 illustrates a functional block diagram of a communication station that may be suitable for use as an AP 102 (FIG. 1) or a user device 120 (FIG. 1) in accordance with some embodiments. The communication station 1500 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 1500 may include communications circuitry 1502 and a transceiver 1510 for transmitting and receiving signals to and from other communication stations using one or more antennas 1501. The communications circuitry 1502 may include circuitry that can operate the physical layer (PHY) communications and/or medium access control (MAC) communications for controlling access to the wireless medium, and/or any other communications layers for transmitting and receiving signals. The communication station 1500 may also include processing circuitry 1506 and memory 1508 arranged to perform the operations described herein. In some embodiments, the communications circuitry 1502 and the processing circuitry 1506 may be configured to perform operations detailed in the above figures, diagrams, and flows.

In accordance with some embodiments, the communications circuitry 1502 may be arranged to contend for a wireless medium and configure frames or packets for communicating over the wireless medium. The communications circuitry 1502 may be arranged to transmit and receive signals. The communications circuitry 1502 may also include circuitry for modulation/demodulation, upconversion/downconversion, filtering, amplification, etc. In some embodiments, the processing circuitry 1506 of the communication station 1500 may include one or more processors. In other embodiments, two or more antennas 1501 may be coupled to the communications circuitry 1502 arranged for sending and receiving signals. The memory 1508 may store information for configuring the processing circuitry 1506 to perform operations for configuring and transmitting message frames and performing the various operations described herein. The memory 1508 may include any type of memory, including non-transitory memory, for storing information in a form readable by a machine (e.g., a computer). For example, the memory 1508 may include a computer-readable storage device, read-only memory (ROM), random-access memory (RAM), magnetic disk storage media, optical storage media, flash-memory devices and other storage devices and media.

In some embodiments, the communication station 1500 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 1500 may include one or more antennas 1501. The antennas 1501 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 1500 may include one or more of a keyboard, a display, a non-volatile memory port, multiple antennas, a graphics processor, an application processor, speakers, and other mobile device elements. The display may be an LCD screen including a touch screen.

Although the communication station 1500 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 1500 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 1500 may include one or more processors and may be configured with instructions stored on a computer-readable storage device.

FIG. 16 illustrates a block diagram of an example of a machine 1600 or system upon which any one or more of the techniques (e.g., methodologies) discussed herein may be performed. In other embodiments, the machine 1600 may operate as a standalone device or may be connected (e.g., networked) to other machines. In a networked deployment, the machine 1600 may operate in the capacity of a server machine, a client machine, or both in server-client network environments. In an example, the machine 1600 may act as a peer machine in peer-to-peer (P2P) (or other distributed) network environments. The machine 1600 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 1600 may include a hardware processor 1602 (e.g., a central processing unit (CPU), a graphics processing unit (GPU), a hardware processor core, or any combination thereof), a main memory 1604 and a static memory 1606, some or all of which may communicate with each other via an interlink (e.g., bus) 1608. The machine 1600 may further include a power management device 1632, a graphics display device 1610, an alphanumeric input device 1612 (e.g., a keyboard), and a user interface (UI) navigation device 1614 (e.g., a mouse). In an example, the graphics display device 1610, alphanumeric input device 1612, and UI navigation device 1614 may be a touch screen display. The machine 1600 may additionally include a storage device (i.e., drive unit) 1616, a signal generation device 1618 (e.g., a speaker), an enhanced connectivity device 1619, a network interface device/transceiver 1620 coupled to antenna(s) 1630, and one or more sensors 1628, such as a global positioning system (GPS) sensor, a compass, an accelerometer, or other sensor. The machine 1600 may include an output controller 1634, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 1602 for generation and processing of the baseband signals and for controlling operations of the main memory 1604, the storage device 1616, and/or the enhanced connectivity device 1619. The baseband processor may be provided on a single radio card, a single chip, or an integrated circuit (IC).

The storage device 1616 may include a machine readable medium 1622 on which is stored one or more sets of data structures or instructions 1624 (e.g., software) embodying or utilized by any one or more of the techniques or functions described herein. The instructions 1624 may also reside, completely or at least partially, within the main memory 1604, within the static memory 1606, or within the hardware processor 1602 during execution thereof by the machine 1600. In an example, one or any combination of the hardware processor 1602, the main memory 1604, the static memory 1606, or the storage device 1616 may constitute machine-readable media.

The enhanced connectivity device 1619 may carry out or perform any of the operations and processes (e.g., process 1400) described and shown above.

It is understood that the above are only a subset of what the enhanced connectivity device 1619 may be configured to perform and that other functions included throughout this disclosure may also be performed by the enhanced connectivity device 1619.

While the machine-readable medium 1622 is illustrated as a single medium, the term “machine-readable medium” may include a single medium or multiple media (e.g., a centralized or distributed database, and/or associated caches and servers) configured to store the one or more instructions 1624.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 1600 and that cause the machine 1600 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 1624 may further be transmitted or received over a communications network 1626 using a transmission medium via the network interface device/transceiver 1620 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1620 may include one or more physical jacks (e.g., Ethernet, coaxial, or phone jacks) or one or more antennas to connect to the communications network 1626. In an example, the network interface device/transceiver 1620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1600 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

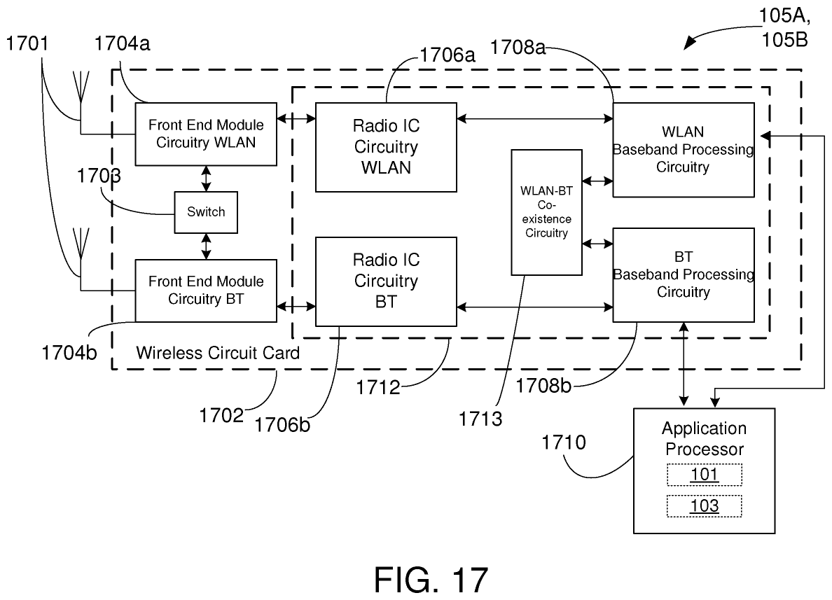

FIG. 17 is a block diagram of a radio architecture 105A, 105B in accordance with some embodiments that may be implemented in any one of the example APs 102 and/or the example STAs 120 of FIG. 1. Radio architecture 105A, 105B may include radio front-end module (FEM) circuitry 1704a-b, radio IC circuitry 1706a-b and baseband processing circuitry 1708a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 1704a-b may include a WLAN or Wi-Fi FEM circuitry 1704a and a Bluetooth (BT) FEM circuitry 1704b. The WLAN FEM circuitry 1704a may include a receive signal path comprising circuitry configured to operate on WLAN RF signals received from one or more antennas 1701, to amplify the received signals and to provide the amplified versions of the received signals to the WLAN radio IC circuitry 1706a for further processing. The BT FEM circuitry 1704b may include a receive signal path which may include circuitry configured to operate on BT RF signals received from one or more antennas 1701, to amplify the received signals and to provide the amplified versions of the received signals to the BT radio IC circuitry 1706b for further processing. FEM circuitry 1704a may also include a transmit signal path which may include circuitry configured to amplify WLAN signals provided by the radio IC circuitry 1706a for wireless transmission by one or more of the antennas 1701. In addition, FEM circuitry 1704b may also include a transmit signal path which may include circuitry configured to amplify BT signals provided by the radio IC circuitry 1706b for wireless transmission by the one or more antennas. In the embodiment of FIG. 17, although FEM 1704a and FEM 1704b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 1706a-b as shown may include WLAN radio IC circuitry 1706a and BT radio IC circuitry 1706b. The WLAN radio IC circuitry 1706a may include a receive signal path which may include circuitry to down-convert WLAN RF signals received from the FEM circuitry 1704a and provide baseband signals to WLAN baseband processing circuitry 1708a. BT radio IC circuitry 1706b may in turn include a receive signal path which may include circuitry to down-convert BT RF signals received from the FEM circuitry 1704b and provide baseband signals to BT baseband processing circuitry 1708b. WLAN radio IC circuitry 1706a may also include a transmit signal path which may include circuitry to up-convert WLAN baseband signals provided by the WLAN baseband processing circuitry 1708a and provide WLAN RF output signals to the FEM circuitry 1704a for subsequent wireless transmission by the one or more antennas 1701. BT radio IC circuitry 1706b may also include a transmit signal path which may include circuitry to up-convert BT baseband signals provided by the BT baseband processing circuitry 1708b and provide BT RF output signals to the FEM circuitry 1704b for subsequent wireless transmission by the one or more antennas 1701. In the embodiment of FIG. 17, although radio IC circuitries 1706a and 1706b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuity 1708a-b may include a WLAN baseband processing circuitry 1708a and a BT baseband processing circuitry 1708b. The WLAN baseband processing circuitry 1708a may include a memory, such as, for example, a set of RAM arrays in a Fast Fourier Transform or Inverse Fast Fourier Transform block (not shown) of the WLAN baseband processing circuitry 1708a. Each of the WLAN baseband circuitry 1708a and the BT baseband circuitry 1708b may further include one or more processors and control logic to process the signals received from the corresponding WLAN or BT receive signal path of the radio IC circuitry 1706a-b, and to also generate corresponding WLAN or BT baseband signals for the transmit signal path of the radio IC circuitry 1706a-b. Each of the baseband processing circuitries 1708a and 1708b may further include physical layer (PHY) and medium access control layer (MAC) circuitry, and may further interface with a device for generation and processing of the baseband signals and for controlling operations of the radio IC circuitry 1706a-b.

Referring still to FIG. 17, according to the shown embodiment, WLAN-BT coexistence circuitry 1713 may include logic providing an interface between the WLAN baseband circuitry 1708a and the BT baseband circuitry 1708b to enable use cases requiring WLAN and BT coexistence. In addition, a switch 1703 may be provided between the WLAN FEM circuitry 1704a and the BT FEM circuitry 1704b to allow switching between the WLAN and BT radios according to application needs. In addition, although the antennas 1701 are depicted as being respectively connected to the WLAN FEM circuitry 1704a and the BT FEM circuitry 1704b, embodiments include within their scope the sharing of one or more antennas as between the WLAN and BT FEMs, or the provision of more than one antenna connected to each of FEM 1704a or 1704b.

In some embodiments, the front-end module circuitry 1704a-b, the radio IC circuitry 1706a-b, and baseband processing circuitry 1708a-b may be provided on a single radio card, such as wireless radio card 1702. In some other embodiments, the one or more antennas 1701, the FEM circuitry 1704a-b and the radio IC circuitry 1706a-b may be provided on a single radio card. In some other embodiments, the radio IC circuitry 1706a-b and the baseband processing circuitry 1708a-b may be provided on a single chip or integrated circuit (IC), such as IC 1712.

In some embodiments, the wireless radio card 1702 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 17, the BT baseband circuitry 1708b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

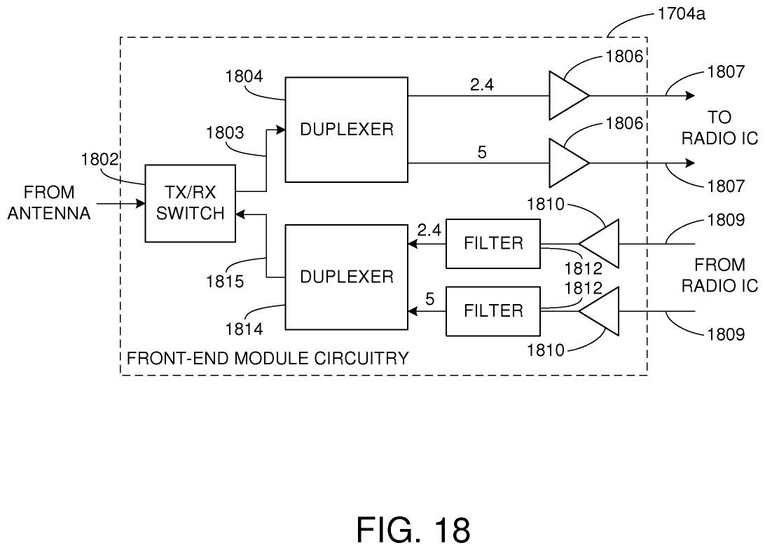

FIG. 18 illustrates WLAN FEM circuitry 1704a in accordance with some embodiments. Although the example of FIG. 18 is described in conjunction with the WLAN FEM circuitry 1704a, the example of FIG. 18 may be described in conjunction with the example BT FEM circuitry 1704b (FIG. 17), although other circuitry configurations may also be suitable.

In some embodiments, the FEM circuitry 1704a may include a TX/RX switch 1802 to switch between transmit mode and receive mode operation. The FEM circuitry 1704a may include a receive signal path and a transmit signal path. The receive signal path of the FEM circuitry 1704a may include a low-noise amplifier (LNA) 1806 to amplify received RF signals 1803 and provide the amplified received RF signals 1807 as an output (e.g., to the radio IC circuitry 1706a-b (FIG. 17)). The transmit signal path of the circuitry 1704a may include a power amplifier (PA) to amplify input RF signals 1809 (e.g., provided by the radio IC circuitry 1706a-b), and one or more filters 1812, such as band-pass filters (BPFs), low-pass filters (LPFs) or other types of filters, to generate RF signals 1815 for subsequent transmission (e.g., by one or more of the antennas 1701 (FIG. 17)) via an example duplexer 1814.

In some dual-mode embodiments for Wi-Fi communication, the FEM circuitry 1704a may be configured to operate in either the 2.4 GHz frequency spectrum or the 5 GHz frequency spectrum. In these embodiments, the receive signal path of the FEM circuitry 1704a may include a receive signal path duplexer 1804 to separate the signals from each spectrum as well as provide a separate LNA 1806 for each spectrum as shown. In these embodiments, the transmit signal path of the FEM circuitry 1704a may also include a power amplifier 1810 and a filter 1812, such as a BPF, an LPF or another type of filter for each frequency spectrum and a transmit signal path duplexer 1804 to provide the signals of one of the different spectrums onto a single transmit path for subsequent transmission by the one or more of the antennas 1701 (FIG. 17). In some embodiments, BT communications may utilize the 2.4 GHz signal paths and may utilize the same FEM circuitry 1704a as the one used for WLAN communications.

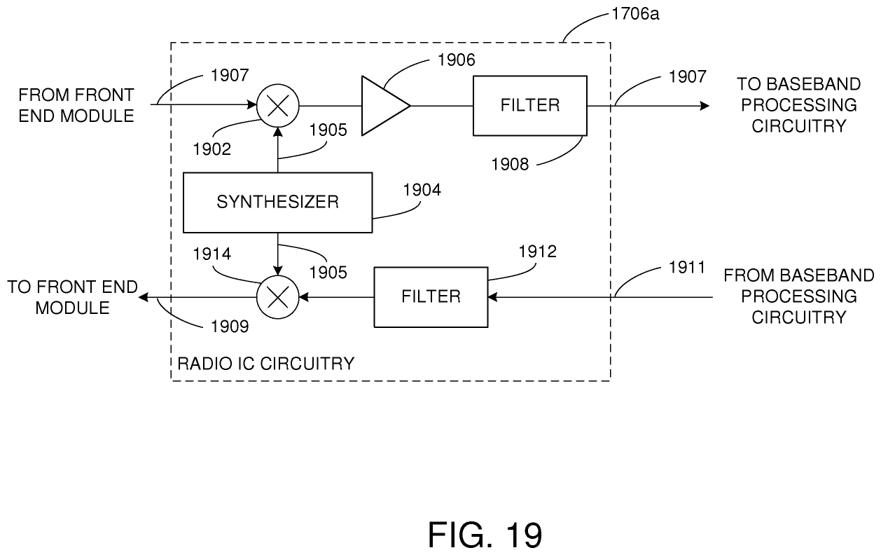

FIG. 19 illustrates radio IC circuitry 1706a in accordance with some embodiments. The radio IC circuitry 1706a is one example of circuitry that may be suitable for use as the WLAN or BT radio IC circuitry 1706a/1706b (FIG. 17), although other circuitry configurations may also be suitable. Alternatively, the example of FIG. 19 may be described in conjunction with the example BT radio IC circuitry 1706b.

In some embodiments, the radio IC circuitry 1706a may include a receive signal path and a transmit signal path. The receive signal path of the radio IC circuitry 1706a may include at least mixer circuitry 1902, such as, for example, down-conversion mixer circuitry, amplifier circuitry 1906 and filter circuitry 1908. The transmit signal path of the radio IC circuitry 1706a may include at least filter circuitry 1912 and mixer circuitry 1914, such as, for example, up-conversion mixer circuitry. Radio IC circuitry 1706a may also include synthesizer circuitry 1904 for synthesizing a frequency 1905 for use by the mixer circuitry 1902 and the mixer circuitry 1914. The mixer circuitry 1902 and/or 1914 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 19 illustrates only a simplified version of a radio IC circuitry, and may include, although not shown, embodiments where each of the depicted circuitries may include more than one component. For instance, mixer circuitry 1914 may each include one or more mixers, and filter circuitries 1908 and/or 1912 may each include one or more filters, such as one or more BPFs and/or LPFs according to application needs. For example, when mixer circuitries are of the direct-conversion type, they may each include two or more mixers.

In some embodiments, mixer circuitry 1902 may be configured to down-convert RF signals 1807 received from the FEM circuitry 1704a-b (FIG. 17) based on the synthesized frequency 1905 provided by synthesizer circuitry 1904. The amplifier circuitry 1906 may be configured to amplify the down-converted signals and the filter circuitry 1908 may include an LPF configured to remove unwanted signals from the down-converted signals to generate output baseband signals 1907. Output baseband signals 1907 may be provided to the baseband processing circuitry 1708a-b (FIG. 17) for further processing. In some embodiments, the output baseband signals 1907 may be zero-frequency baseband signals, although this is not a requirement. In some embodiments, mixer circuitry 1902 may comprise passive mixers, although the scope of the embodiments is not limited in this respect.

In some embodiments, the mixer circuitry 1914 may be configured to up-convert input baseband signals 1911 based on the synthesized frequency 1905 provided by the synthesizer circuitry 1904 to generate RF output signals 1809 for the FEM circuitry 1704a-b. The baseband signals 1911 may be provided by the baseband processing circuitry 1708a-b and may be filtered by filter circuitry 1912. The filter circuitry 1912 may include an LPF or a BPF, although the scope of the embodiments is not limited in this respect.

In some embodiments, the mixer circuitry 1902 and the mixer circuitry 1914 may each include two or more mixers and may be arranged for quadrature down-conversion and/or up-conversion respectively with the help of synthesizer 1904. In some embodiments, the mixer circuitry 1902 and the mixer circuitry 1914 may each include two or more mixers each configured for image rejection (e.g., Hartley image rejection). In some embodiments, the mixer circuitry 1902 and the mixer circuitry 1914 may be arranged for direct down-conversion and/or direct up-conversion, respectively. In some embodiments, the mixer circuitry 1902 and the mixer circuitry 1914 may be configured for super-heterodyne operation, although this is not a requirement.

Mixer circuitry 1902 may comprise, according to one embodiment: quadrature passive mixers (e.g., for the in-phase (I) and quadrature phase (Q) paths). In such an embodiment, RF input signal 1807 from FIG. 19 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1905 of synthesizer 1904 (FIG. 19). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction in power consumption.

The RF input signal 1807 (FIG. 18) may comprise a balanced signal, although the scope of the embodiments is not limited in this respect. The I and Q baseband output signals may be provided to low-noise amplifier, such as amplifier circuitry 1906 (FIG. 19) or to filter circuitry 1908 (FIG. 19).

In some embodiments, the output baseband signals 1907 and the input baseband signals 1911 may be analog baseband signals, although the scope of the embodiments is not limited in this respect. In some alternate embodiments, the output baseband signals 1907 and the input baseband signals 1911 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1904 may be a fractional-N synthesizer or a fractional N/N+1 synthesizer, although the scope of the embodiments is not limited in this respect as other types of frequency synthesizers may be suitable. For example, synthesizer circuitry 1904 may be a delta-sigma synthesizer, a frequency multiplier, or a synthesizer comprising a phase-locked loop with a frequency divider. According to some embodiments, the synthesizer circuitry 1904 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuity 1904 may be provided by a voltage controlled oscillator (VCO), although that is not a requirement. A divider control input may further be provided by either the baseband processing circuitry 1708a-b (FIG. 17) depending on the desired output frequency 1905. In some embodiments, a divider control input (e.g., N) may be determined from a look-up table (e.g., within a Wi-Fi card) based on a channel number and a channel center frequency as determined or indicated by the example application processor 1710. The application processor 1710 may include, or otherwise be connected to, one of the example secure signal converter 101 or the example received signal converter 103 (e.g., depending on which device the example radio architecture is implemented in).

In some embodiments, synthesizer circuitry 1904 may be configured to generate a carrier frequency as the output frequency 1905, while in other embodiments, the output frequency 1905 may be a fraction of the carrier frequency (e.g., one-half the carrier frequency, one-third the carrier frequency). In some embodiments, the output frequency 1905 may be a LO frequency (fLO).

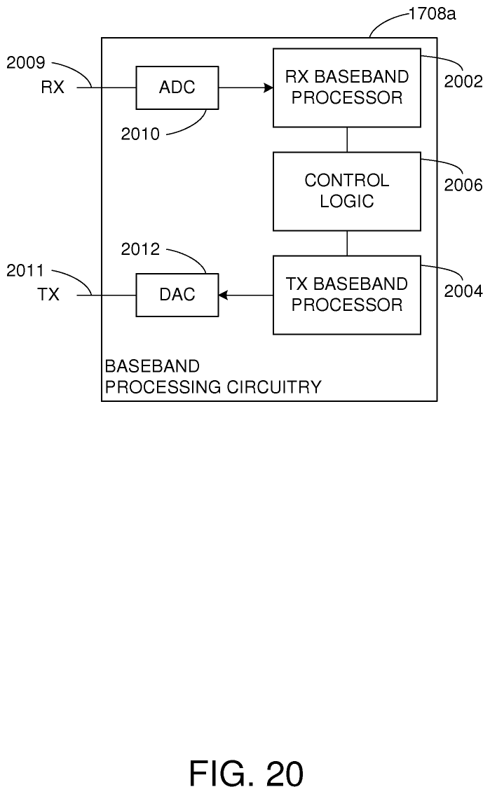

FIG. 20 illustrates a functional block diagram of baseband processing circuitry 1708a in accordance with some embodiments. The baseband processing circuitry 1708a is one example of circuitry that may be suitable for use as the baseband processing circuitry 1708a (FIG. 17), although other circuitry configurations may also be suitable. Alternatively, the example of FIG. 19 may be used to implement the example BT baseband processing circuitry 1708b of FIG. 17.

The baseband processing circuitry 1708a may include a receive baseband processor (RX BBP) 2002 for processing receive baseband signals 1909 provided by the radio IC circuitry 1706a-b (FIG. 17) and a transmit baseband processor (TX BBP) 2004 for generating transmit baseband signals 1911 for the radio IC circuitry 1706a-b. The baseband processing circuitry 1708a may also include control logic 2006 for coordinating the operations of the baseband processing circuitry 1708a.

In some embodiments (e.g., when analog baseband signals are exchanged between the baseband processing circuitry 1708a-b and the radio IC circuitry 1706a-b), the baseband processing circuitry 1708a may include ADC 2010 to convert analog baseband signals 2009 received from the radio IC circuitry 1706a-b to digital baseband signals for processing by the RX BBP 2002. In these embodiments, the baseband processing circuitry 1708a may also include DAC 2012 to convert digital baseband signals from the TX BBP 2004 to analog baseband signals 2011.

In some embodiments that communicate OFDM signals or OFDMA signals, such as through baseband processor 1708a, the transmit baseband processor 2004 may be configured to generate OFDM or OFDMA signals as appropriate for transmission by performing an inverse fast Fourier transform (IFFT). The receive baseband processor 2002 may be configured to process received OFDM signals or OFDMA signals by performing an FFT. In some embodiments, the receive baseband processor 2002 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 17, in some embodiments, the antennas 1701 (FIG. 17) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 1701 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.
Example 1 may include a device comprising processing circuitry coupled to storage, the processing circuitry configured to: generate a preamble comprising a signal duplicated across a plurality of frequency portions of a bandwidth; determine a phase rotation for each copy of the signal based on a number of the frequency portions; apply the phase rotation to each copy to reduce a peak-to-average power ratio of the preamble; and transmit the preamble based on the phase rotation.
Example 2 may include the device of example 1 and/or some other example(s) herein, wherein the phase rotation comprises a global phase rotation applied to each copy, the global phase rotation being a binary phase or a quaternary phase.
Example 3 may include the device of example 1 and/or some other example(s) herein, wherein the processing circuitry may be further configured to apply a respective cyclic shift to each copy, the phase rotation comprising a linear phase shift based on a global phase and the respective cyclic shift.
Example 4 may include the device of example 1 and/or some other example(s) herein, wherein the phase rotation comprises a phase mask applied to each copy, the phase mask comprising a binary sequence.
Example 5 may include the device of example 4 and/or some other example(s) herein, wherein the phase mask comprises a non-binary sequence or a non-periodic sequence, each element of the phase mask multiplied with a symbol on a corresponding subcarrier.
Example 6 may include the device of example 1 and/or some other example(s) herein, wherein the processing circuitry may be further configured to reduce a number of active subcarriers of the preamble based on the peak-to-average power ratio.
Example 7 may include the device of example 1 and/or some other example(s) herein, wherein the processing circuitry may be further configured to boost a power of an active subcarrier based on an inactive subcarrier of the bandwidth.
Example 8 may include the device of example 1 and/or some other example(s) herein, wherein the processing circuitry may be further configured to map a first copy and a second copy of the signal based on different symbol orders or different constellation mappings.
Example 9 may include the device of example 1 and/or some other example(s) herein, wherein the processing circuitry may be further configured to generate an indication of whether channel smoothing may be supported across the frequency portions.
Example 10 may include a non-transitory computer-readable medium storing computer-executable instructions which when executed by one or more processors result in performing operations comprising: generating a preamble comprising a signal duplicated across a plurality of frequency portions of a bandwidth; determining a phase rotation for each copy of the signal based on a number of the frequency portions; applying the phase rotation to each copy to reduce a peak-to-average power ratio of the preamble; and transmitting the preamble based on the phase rotation.
Example 11 may include the non-transitory computer-readable medium of example 10 and/or some other example(s) herein, wherein the phase rotation comprises a global phase rotation applied to each copy, the global phase rotation being a binary phase or a quaternary phase.
Example 12 may include the non-transitory computer-readable medium of example 10 and/or some other example(s) herein, wherein the operations further comprise applying a respective cyclic shift to each copy, the phase rotation comprising a linear phase shift based on a global phase and the respective cyclic shift.
Example 13 may include the non-transitory computer-readable medium of example 10 and/or some other example(s) herein, wherein the phase rotation comprises a phase mask applied to each copy, the phase mask comprising a binary sequence.
Example 14 may include the non-transitory computer-readable medium of example 13 and/or some other example(s) herein, wherein the phase mask comprises a non-binary sequence or a non-periodic sequence, each element of the phase mask multiplied with a symbol on a corresponding subcarrier.
Example 15 may include the non-transitory computer-readable medium of example 10 and/or some other example(s) herein, wherein the operations further comprise reducing a number of active subcarriers of the preamble based on the peak-to-average power ratio.
Example 16 may include the non-transitory computer-readable medium of example 10 and/or some other example(s) herein, wherein the operations further comprise boosting a power of an active subcarrier based on an inactive subcarrier of the bandwidth.
Example 17 may include the non-transitory computer-readable medium of example 10 and/or some other example(s) herein, wherein the operations further comprise mapping a first copy and a second copy of the signal based on different symbol orders or different constellation mappings.
Example 18 may include the non-transitory computer-readable medium of example 10 and/or some other example(s) herein, wherein the operations further comprise generating an indication of whether channel smoothing may be supported across the frequency portions.
Example 19 may include a method comprising: generating a preamble comprising a signal duplicated across a plurality of frequency portions of a bandwidth; determining a phase rotation for each copy of the signal based on a number of the frequency portions; applying the phase rotation to each copy to reduce a peak-to-average power ratio of the preamble; and transmitting the preamble based on the phase rotation.
Example 20 may include the method of example 19 and/or some other example(s) herein, wherein the phase rotation comprises a global phase rotation applied to each copy, the global phase rotation being a binary phase or a quaternary phase.
Example 21 may include the method of example 19 and/or some other example(s) herein, the method further comprising applying a respective cyclic shift to each copy, the phase rotation comprising a linear phase shift based on a global phase and the respective cyclic shift.
Example 22 may include the method of example 19 and/or some other example(s) herein, wherein the phase rotation comprises a phase mask applied to each copy, the phase mask comprising a binary sequence.
Example 23 may include the method of example 22 and/or some other example(s) herein, wherein the phase mask comprises a non-binary sequence or a non-periodic sequence, each element of the phase mask multiplied with a symbol on a corresponding subcarrier.
Example 24 may include the method of example 19 and/or some other example(s) herein, the method further comprising reducing a number of active subcarriers of the preamble based on the peak-to-average power ratio.
Example 25 may include the method of example 19 and/or some other example(s) herein, the method further comprising boosting a power of an active subcarrier based on an inactive subcarrier of the bandwidth.
Example 26 may include the method of example 19 and/or some other example(s) herein, the method further comprising mapping a first copy and a second copy of the signal based on different symbol orders or different constellation mappings.
Example 27 may include the method of example 19 and/or some other example(s) herein, the method further comprising generating an indication of whether channel smoothing may be supported across the frequency portions.
Example 28 may include an apparatus comprising means for: generating a preamble comprising a signal duplicated across a plurality of frequency portions of a bandwidth; determining a phase rotation for each copy of the signal based on a number of the frequency portions; applying the phase rotation to each copy to reduce a peak-to-average power ratio of the preamble; and transmitting the preamble based on the phase rotation.
Example 29 may include the apparatus of example 28 and/or some other example(s) herein, wherein the phase rotation comprises a global phase rotation applied to each copy, the global phase rotation being a binary phase or a quaternary phase.
Example 30 may include the apparatus of example 28 and/or some other example(s) herein, further comprising applying a respective cyclic shift to each copy, the phase rotation comprising a linear phase shift based on a global phase and the respective cyclic shift.
Example 31 may include the apparatus of example 28 and/or some other example(s) herein, wherein the phase rotation comprises a phase mask applied to each copy, the phase mask comprising a binary sequence.
Example 32 may include the apparatus of example 31 and/or some other example(s) herein, wherein the phase mask comprises a non-binary sequence or a non-periodic sequence, each element of the phase mask multiplied with a symbol on a corresponding subcarrier.
Example 33 may include the apparatus of example 28 and/or some other example(s) herein, further comprising reducing a number of active subcarriers of the preamble based on the peak-to-average power ratio.
Example 34 may include the apparatus of example 28 and/or some other example(s) herein, further comprising boosting a power of an active subcarrier based on an inactive subcarrier of the bandwidth.
Example 35 may include the apparatus of example 28 and/or some other example(s) herein, further comprising mapping a first copy and a second copy of the signal based on different symbol orders or different constellation mappings.
Example 36 may include the apparatus of example 28 and/or some other example(s) herein, further comprising generating an indication of whether channel smoothing may be supported across the frequency portions.
Example 37 may include one or more non-transitory computer-readable media comprising instructions to cause an electronic device, upon execution of the instructions by one or more processors of the electronic device, to perform one or more elements of a method described in or related to any of examples 1-36, or any other method or process described herein.
Example 38 may include an apparatus comprising logic, modules, and/or circuitry to perform one or more elements of a method described in or related to any of examples 1-36, or any other method or process described herein.
Example 39 may include a method, technique, or process as described in or related to any of examples 1-36, or portions or parts thereof.
Example 40 may include an apparatus comprising: one or more processors and one or more computer readable media comprising instructions that, when executed by the one or more processors, cause the one or more processors to perform the method, techniques, or process as described in or related to any of examples 1-36, or portions thereof.
Example 41 may include a method of communicating in a wireless network as shown and described herein.
Example 42 may include a system for providing wireless communication as shown and described herein.
Example 43 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device comprising processing circuitry coupled to storage, the processing circuitry configured to:
generate a preamble comprising a signal duplicated across a plurality of frequency portions of a bandwidth;
determine a phase rotation for each copy of the signal based on a number of the frequency portions;
apply the phase rotation to each copy to reduce a peak-to-average power ratio of the preamble; and
transmit the preamble based on the phase rotation.

2. The device of claim 1, wherein the phase rotation comprises a global phase rotation applied to each copy, the global phase rotation being a binary phase or a quaternary phase.

3. The device of claim 1, wherein the processing circuitry is further configured to apply a respective cyclic shift to each copy, the phase rotation comprising a linear phase shift based on a global phase and the respective cyclic shift.

4. The device of claim 1, wherein the phase rotation comprises a phase mask applied to each copy, the phase mask comprising a binary sequence.

5. The device of claim 4, wherein the phase mask comprises a non-binary sequence or a non-periodic sequence, each element of the phase mask multiplied with a symbol on a corresponding subcarrier.

6. The device of claim 1, wherein the processing circuitry is further configured to reduce a number of active subcarriers of the preamble based on the peak-to-average power ratio.

7. The device of claim 1, wherein the processing circuitry is further configured to boost a power of an active subcarrier based on an inactive subcarrier of the bandwidth.

8. The device of claim 1, wherein the processing circuitry is further configured to map a first copy and a second copy of the signal based on different symbol orders or different constellation mappings.

9. The device of claim 1, wherein the processing circuitry is further configured to generate an indication of whether channel smoothing is supported across the frequency portions.

10. A non-transitory computer-readable medium storing computer-executable instructions which when executed by one or more processors result in performing operations comprising:
generating a preamble comprising a signal duplicated across a plurality of frequency portions of a bandwidth;
determining a phase rotation for each copy of the signal based on a number of the frequency portions;
applying the phase rotation to each copy to reduce a peak-to-average power ratio of the preamble; and
transmitting the preamble based on the phase rotation.

11. The non-transitory computer-readable medium of claim 10, wherein the phase rotation comprises a global phase rotation applied to each copy, the global phase rotation being a binary phase or a quaternary phase.

12. The non-transitory computer-readable medium of claim 10, wherein the operations further comprise applying a respective cyclic shift to each copy, the phase rotation comprising a linear phase shift based on a global phase and the respective cyclic shift.

13. The non-transitory computer-readable medium of claim 10, wherein the phase rotation comprises a phase mask applied to each copy, the phase mask comprising a binary sequence.

14. The non-transitory computer-readable medium of claim 13, wherein the phase mask comprises a non-binary sequence or a non-periodic sequence, each element of the phase mask multiplied with a symbol on a corresponding subcarrier.

15. The non-transitory computer-readable medium of claim 10, wherein the operations further comprise reducing a number of active subcarriers of the preamble based on the peak-to-average power ratio.

16. The non-transitory computer-readable medium of claim 10, wherein the operations further comprise boosting a power of an active subcarrier based on an inactive subcarrier of the bandwidth.

17. The non-transitory computer-readable medium of claim 10, wherein the operations further comprise mapping a first copy and a second copy of the signal based on different symbol orders or different constellation mappings.

18. The non-transitory computer-readable medium of claim 10, wherein the operations further comprise generating an indication of whether channel smoothing is supported across the frequency portions.

19. A method comprising:
generating a preamble comprising a signal duplicated across a plurality of frequency portions of a bandwidth;
determining a phase rotation for each copy of the signal based on a number of the frequency portions;
applying the phase rotation to each copy to reduce a peak-to-average power ratio of the preamble; and
transmitting the preamble based on the phase rotation.

20. The method of claim 19, wherein the phase rotation comprises a global phase rotation applied to each copy, the global phase rotation being a binary phase or a quaternary phase.
